(19) United States
(12) Patent Application Publication
(10) Pub. No.: US 2018/0367431 A1
(43) Pub. Date: Dec. 20, 2018

(54) HEAVY NETWORK FLOW DETECTION METHOD AND SOFTWARE-DEFINED NETWORKING SWITCH

(71) Applicant: Chung Yuan Christian University, Taoyuan City (TW)

(72) Inventors: Yu-Kuen Lai, Taoyuan City (TW); Theophilus Yohanis Hermanus Wellem, Taoyuan City (TW); Chao-Yuan Huang, New Taipei City (TW); Chung-Hsiang Cheng, New Taipei City (TW); Yung-Chuan Liao, Yunlin County (TW); Li-Ting Chen, Taichung City (TW)

(73) Assignee: Chung Yuan Christian University, Taoyuan City (TW)

(21) Appl. No.: 15/659,628

(22) Filed: Jul. 26, 2017

(30) Foreign Application Priority Data
Jun. 14, 2017 (TW) 106119890

(51) Int. Cl. H04L 12/26

(52) U.S. Cl. CPC H04L 43/0876; H04L 43/12; H04L 43/16

(57) ABSTRACT

An embodiment of the invention provides a heavy network flow detection method for a software-defined networking (SDN) switch. The method includes: receiving a network packet through a network interface; analyzing the network packet to obtain routing information of the network packet; performing a plurality of hash calculations for the routing information to generate a plurality of index values, and updating a plurality of counting values in a plurality of hash tables according to the index values; obtaining a flow-amount evaluation value corresponding to the routing information according to the counting values; and identifying that the network packet belongs to a heavy network flow if the flow-amount evaluation value is larger than a threshold value.

### CROSS-REFERENCE TO RELATED APPLICATION

This application claims the priority benefit of Taiwan application serial no. 106119890, filed on Jun. 14, 2017. The entirety of the above-mentioned patent application is hereby incorporated by reference herein and made a part of this specification.

### BACKGROUND OF THE INVENTION

### Field of the Invention

The invention relates to a network management technique, particularly relates to a heavy network flow detection method and software-defined networking (SDN) switch.

### Description of Related Art

Software-defined networking (SDN) is a network virtualization technology. SDN overturns the long-standing network architecture by changing control mode of traditional network architecture from distributed control into centralized control, so that network equipments tend to be more standardized and simplified. The main concept of the SDN technology is to adopt a generic “data flow table” for data exchange. The routing and exchanging information in the network may be expressed as a data flow entry and be stored into the data flow table. The data flow entry in the data flow table may be used to describe forwarding policy, data operation, data state and the like.

A SDN network generally includes multiple network equipments (e.g., SDN switches) and a SDN controller. The SDN controller is in charge of a routing control. For example, the SDN controller may generate the data flow table according to user's configuration or a dynamically operated protocol and configure the data flow table to the corresponding SDN switch. The SDN switch is in charge of a data flow (e.g., network packets) forwarding based on the configured data flow table.

In the SDN network, information related to the data flow is generally reported back to the SDN controller from the disposed SDN switch and quantitative analysis for the data flow is performed by the SDN controller. As a result, the network state of the SDN network, such as flow amount information of data flow from different Internet protocol addresses, can be obtained and monitored by the SDN controller. However, the centralized calculation and monitoring mechanism for entire SDN network may substantially increases the calculation payload of the SDN controller and lead to the lack of timeliness for flow management.

### SUMMARY OF THE INVENTION

The invention is directed to a heavy network flow detection method and software-defined networking (SDN) switch, which are capable of analyzing the data flow by the SND switch to identify a heavy network flow in the SND network immediately.

An embodiment of the invention provides a heavy network flow detection method for a SDN switch. The heavy network flow detection method comprises: receiving a network packet through a network interface; analyzing the network packet to obtain routing information of the network packet; performing a plurality of hash calculations for the routing information to generate a plurality of index values and updating a plurality of counting values in a plurality of hash tables according to the index values; obtaining a flow-amount evaluation value corresponding to the routing information according to the counting values; and identifying that the network packet belongs to a heavy network flow if the flow-amount evaluation value is larger than a threshold value.

Another embodiment of the invention provides a SDN switch for a SDN network, the SDN switch comprises a network interface, a packet analysis interface, and a heavy network flow detection circuit. The network interface is configured to receive a network packet. The packet analysis interface is coupled to the network interface and configured to analyze the network packet to obtain routing information of the network packet. The heavy network flow detection circuit is coupled to the packet analysis interface and configured to perform a plurality of hash calculations for the routing information to generate a plurality of index values and update a plurality of counting values in a plurality of hash tables according to the index values. The heavy network flow detection circuit is further configured to obtain a flow-amount evaluation value corresponding to the routing information according to the counting values. The heavy network flow detection circuit is further configured to identify that the network packet belongs to a heavy network flow if the flow-amount evaluation value is larger than a threshold value.

According to the above descriptions, after the network packet is received, the SDN switch may analyse the network packet to obtain a routing information of the network packet and obtain a corresponding flow-amount evaluation value by performing multiple hash calculations in parallel and a counting value updating operation. If the flow-amount evaluation value is larger than a threshold value, the SDN switch may identify that the network packet belongs to a heavy network flow. As a result, the efficiency of flow analysis and flow management in the SDN network can be improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a software-defined networking (SDN) system according to an embodiment of the invention.

FIG. 2 is a schematic diagram of a SDN switch according to an embodiment of the invention.

FIG. 3 is a schematic diagram illustrating an operation of updating the counting values according to an embodiment of the invention.

FIG. 4 is a schematic diagram illustrating an operation of updating the counting values according to another embodiment of the invention.

FIG. 5 is a schematic diagram of a heavy network flow detection circuit according to an embodiment of the invention.

FIG. 6 is a flowchart illustrating a heavy network flow detection method according to an embodiment of the invention.

### DESCRIPTION OF EMBODIMENTS

FIG. 1 is a schematic diagram of a software-defined networking (SDN) system according to an embodiment of the invention. Referring to FIG. 1, the SDN system 10 includes a SDN controller 11 and a SDN group 12. The SDN group 12 includes a plurality of SDN switches 121 to 124. The SDN switches 121 to 124 are controlled by the SDN controller 11. The SDN controller 11 is a network control device supporting SND control functions, such as routing management and so on. The SDN controller 11 may be a physical device (e.g., a base station or an accessing point) or a virtual machine configured in an electronic device. Each of the SDN switches 121 to 124 supports SDN routing function. For example, each of the SDN switches 121 to 124 may be a physical switch or a virtual switch configured in an electronic device (e.g., the Open vSwitch). Alternatively, at least one of the SDN switches 121 to 124 may also be a network communication device supporting routing mechanism with different type, such as a router and so on, which is not particularly limited in the invention. In addition, the number of the SDN controller 11 may be one or more, and the number of the SDN switches 121 to 124 may also be more or less, which is not particularly limited in the invention.

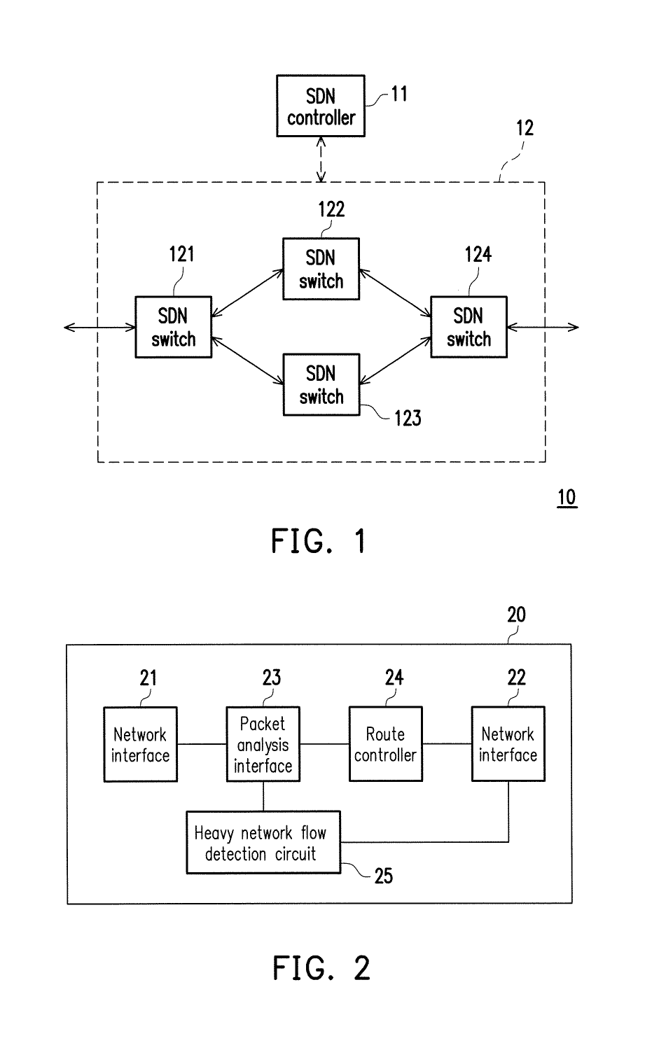

FIG. 2 is a schematic diagram of a SDN switch according to an embodiment of the invention. Referring to FIG. 1 and FIG. 2, the SDN switch 20 may be one of the SDN switches 121 to 124. The SDN switch 20 includes a network interface 21, a network interface 22, a packet analysis interface 23, a route controller 24 and a heavy network flow detection circuit 25. The network interfaces 21 and 22 may include a wire (or wireless) network interface circuit (e.g., Ethernet network interface card) respectively. The network interface 21 is configured to receive network packets (or data flow) from an external network, and the network interface 22 is configured to output network packets (or data flow) to the external network.

The packet analysis interface 23 is coupled to the network interface 21 and is configured to analyse the received network packet. For example, the packet analysis interface 23 may analyse a packet structure of the received network packet, so as to obtain header information and payload information of the network packet. For example, the header information of a network packet may include routing information, packet size information and so on. The routing information may include information related to packet routing, such as a source Internet protocol (IP) address, a destination IP address, a source port number, and a destination port number. The packet size information may present a packet size (or packet length) of the network packet. In addition, the packet analysis interface 23 may be implemented as a software module or a hardware circuit, which is not particularly limited in the invention.

The route controller 24 is coupled to the network interface 22 and the packet analysis interface 23. The route controller 24 may be, for example, a central processing unit (CPU) or other programmable devices for general purpose or special purpose such as a microprocessor and a digital signal processor (DSP), a programmable controller, an application specific integrated circuit (ASIC), a programmable logic device (PLD) or other similar devices or a combination of above-mentioned devices. In addition, the route controller 24 may also include a storage circuit, such as a random access memory (RAM), a read only memory (ROM), a flash memory or similar storage medium or a combination of above-mentioned memory devices.

The route controller 24 is configured to control the routing of network packets passing through the SDN switch 20. For example, the route controller 24 may inquire the corresponding routing rule according to the routing information carried by a network packet, and then determine how to transmit the network packet according to the inquiry result. For example, if it is assumed that the SDN controller 20 is the SDN controller 121, after an input network packet is received through the network interface 21, the route controller 24 may instruct transmitting the network packet through the network interface 22 to SDN switch 122 or 123, depending on the routing rule stored in the SDN switch 121. For example, the routing rule may be configured by the SDN controller 11 and recorded in a data flow table or other routing tables stored in the route controller 24.

More specifically, if it is assumed that a specific network packet is to be transmitted to a specific IP address, after the corresponding routing rule is inquired according to the routing information of this specific network packet, this specific network packet may be transmitted to the SDN switch 122 through a specific connection port of the network interface 22. Alternatively, if it is assumed that a specific network packet is to be transmitted to another specific IP address, after the corresponding routing rule is inquired according to the routing information of this specific network packet, this specific network packet may be transmitted to the SDN switch 123 through another specific connection port of the network interface 22. By analogy, network packets (or data flow) may be transmitted and routed through the switch group 12. In addition, in one embodiment, the route controller 24 is also in charge of the overall operation of the SDN switch 20.

The heavy network flow detection circuit 25 is coupled to the packet analysis interface 23 and the network interface 22. In this embodiment, the heavy network flow detection circuit 25 is a customized circuit module and is disposed independently outside the route controller 24. In addition, the heavy network flow detection circuit 25 may also include a RAM, a ROM, a flash memory or similar storage medium or a combination of above-mentioned memory devices. However, in another embodiment, the heavy network flow detection circuit 25 may be disposed inside the route controller 21 and/or be implemented by a software module, which is not particularly limited in the invention.

The heavy network flow detection circuit 25 is configured to detect a heavy network flow which may exist in the SDN system 10. Here, the heavy network flow may include a great amount of network packets (or data flow) having the same or similar routing information. For example, if a great amount of network packets is from the same source IP address, transmitted to the same destination IP address and/or transmitted by the same connection port number, these network packets may form a heavy network flow. In some cases, when a distributed denial-of-service (DDOS) attack is initiated by an attacker for example, a heavy network flow may cause significantly delay on packet transmission or even shut down the entire SDN system 10 or a part of nodes in the SDN system 10. In addition, in some cases without malicious attack, the heavy network flow may also be generated because too many users connect to the same website or the same web server.

In this embodiment, if the network interface 21 receives an input network packet, the packet analysis interface 23 may analyse the network packet to obtain a routing information of the network packet. For example, the routing information may include at least one of a source IP address of the network packet, a destination IP address of the network packet, a source port number of the network packet and a destination port number of the network packet or other information related to packet routing of the network packet. The heavy network flow detection circuit 25 may perform a plurality of hash calculations for the obtained routing information to generate a plurality of index values and then update a plurality of counting values recorded in a plurality of hash tables.

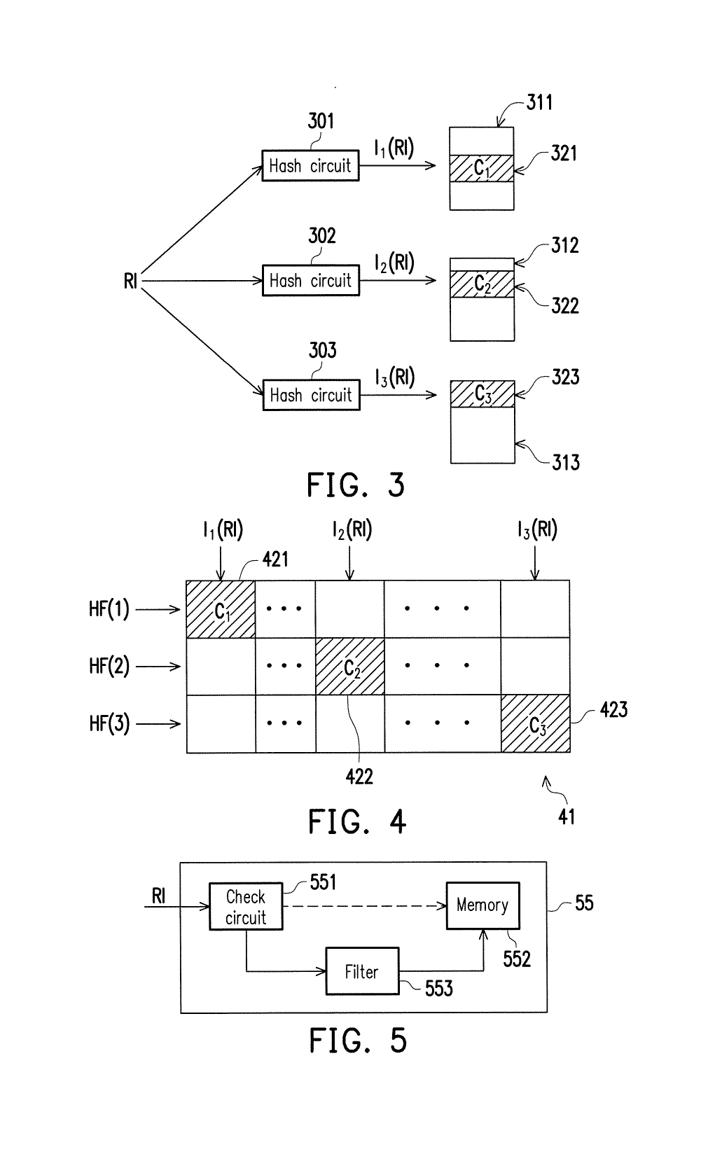

FIG. 3 is a schematic diagram illustrating an operation of updating the counting values according to an embodiment of the invention. Referring to FIG. 2 and FIG. 3, in this embodiment, the heavy network flow detection circuit 25 include a plurality of hash circuits 301 to 303. The hash circuit 301 may perform a hash calculation based on a default hash function (also known as a first hash function), the hash circuit 302 may perform a hash calculation based on another default hash function (also known as a second hash function), and the hash circuit 303 may perform a hash calculation based on yet another default hash function (also known as a third hash function). It is noted that, the first hash function, the second hash function, and the third hash function are different from each other.

If routing information RI is received, the heavy network flow detection circuit 25 input the routing information RI into the hash circuits 301 to 303 to execute the hash calculations in parallel and generate an index value I₁(RI) (also known as a first index value), an index value I₂(RI) (also known as a second index value) and an index value I₃(RI) (also known as a third index value). It is noted that, because the first hash function, the second hash function, and the third hash function are different from each other, in most frequently cases, the generated index values I₁(RI), I₂(RI), and I₃(RI) are also different from each other. However, in very rare cases, at least two index values having the same value may also be generated by the hash circuits 301 to 303 in parallel because of probability collision.

In one embodiment, the above operations of inputting the routing information RI to the hash circuits 301 to 303 for hash calculations and generating the index values I₁(RI), I₂(RI), and I₃(RI) may also be regarded as the operations of inputting the routing information RI to the first hash function, the second hash function and the third hash function to obtain the index values I₁(RI), I₂(RI), and I₃(RI) respectively. Alternatively, from another point of view, the index value I₁(RI) may also be regarded as the output of the first hash function (or the hash circuit 301) after the routing information RI is input to the first hash function (or the hash circuit 301); the index value I₂(RI) may also be regarded as the output of the second hash function (or the hash circuit 302) after the routing information RI is input to the second hash function (or the hash circuit 302); and the index value I₃(RI) may also be regarded as the output of the third hash function (or the hash circuit 303) after the routing information RI is input to the third hash function (or the hash circuit 303).

The heavy network flow detection circuit 25 may update a counting value C₁ in hash table 311 according to the index value I₁(RI), update a counting value C₂ in hash table 312 according to the index value I₂(RI), and update a counting value C₃ in hash table 313 according to the index value I₃(RI). It is noted that, each of the hash tables 311 to 313 may record multiple counting values and each of the counting values may correspond to a specific index value; however, for description convenience, these counting values are not entirely shown in FIG. 3.

More specifically, the first hash function, the second hash function, and the third hash function are related to hash tables 311 to 313, respectively. After the index value I₁(RI) is obtained, the heavy network flow detection circuit 25 may search the data column 321 in the hash table 311 according to the index value I₁(RI) and add an adjustment value to the counting value C₁ to update the counting value C₁. After the index value I₂(RI) is obtained, the heavy network flow detection circuit 25 may search the data column 322 in the hash table 312 according to the index value I₂(RI) and add an adjustment value to the counting value C₂ to update the counting value C₂. After the index value I₃(RI) is obtained, the heavy network flow detection circuit 25 may search the data column 323 in the hash table 313 according to the index value I₃(RI) and add an adjustment value to the counting value C₃ to update the counting value C₃.

In one embodiment, the adjustment value is a default value (e.g., “1”). For example, if it is assumed that the initial values of the counting values C₁ to C₃ are all “0” and the routing information RI includes a source IP address, after a specific network packet is received and a source IP address of this specific network packet is IP_{A}, the heavy network flow detection circuit 25 may input the parameter IP_{A} into the hash circuits 301 to 303 and generate the index values I₁(RI), I₂(RI), and I₃(RI). The heavy network flow detection circuit 25 may find the counting values C₁ to C₃ from the hash tables 311 to 313 according to the index values I₁(RI), I₂(RI), and I₃(RI). Then, the heavy network flow detection circuit 25 may add “1” to each of the counting values C₁ to C₃. As a result, each of the counting values C₁ to C₃ is updated to be “1” and the updated counting values C₁ to C₃ represent that one network packet with the source IP address IP_{A} is already received.

If another network packet with the same source IP address IP_{A} is also received, the heavy network flow detection circuit 25 may input the parameter IP_{A} into the hash circuits 301 to 303 again and generate the index values I₁(RI), I₂(RI), and I₃(RI). The heavy network flow detection circuit 25 may find the counting values C₁ to C₃ from the hash tables 311 to 313 according to the index values I₁(RI), I₂(RI), and I₃(RI) again. Then, the heavy network flow detection circuit 25 may add “1” to each of the counting values C₁ to C₃ again. As a result, each of the counting values C₁ to C₃ is updated to be “2” and the updated counting values C₁ to C₃ represent that two network packet with the source IP address IP_{A} are already received. By analogy, more the network packets with the same source IP address IP_{A} are received, larger the counting values C₁ to C₃ become.

FIG. 4 is a schematic diagram illustrating an operation of updating the counting values according to another embodiment of the invention. Referring to FIG. 3 and FIG. 4, in this embodiment, the hash tables 311 to 313 may be combined as a two-dimensional hash table 41. Each row of the hash table 41 corresponds to one of the hash circuits 301 to 303 (or one of the first hash function, the second hash function and the third hash function). Each column of the hash table 41 corresponds to an index value. In FIG. 4, the first hash function, the second hash function and the third hash function are represented as parameters HF(1), HF(2), and HF(3), respectively. Therefore, a data column 421 may be found and the counting value C₁ may be updated according to the parameter HF(1) and the index value I₁(RI); a data column 422 may be found and the counting value C₂ may be updated according to the parameter HF(2) and the index value I₂(RI); and a data column 423 may be found and the counting value C₃ may be updated according to the parameter HF(3) and the index value I₃(RI). Similar to the foregoing embodiments, more network packets with the same source IP address IP_{A} are received, larger the counting values C₁ to C₃ become.

In one embodiment, the adjustment value is a dynamically changed value. For example, after the received network packet is analyzed and a packet size of this network packet is obtained, the heavy network flow detection circuit 25 may determine the adjustment value according to the packet size. For example, the heavy network flow detection circuit 25 may determine the adjustment value currently used to be the same with the packet size of this network packet. Alternatively, the heavy network flow detection circuit 25 may adjust the adjustment value based on the packet size. For example, the heavy network flow detection circuit 25 may add a base value to the packet size, so as to generate the adjustment value currently used. In addition, the heavy network flow detection circuit 25 may input the packet size to a default algorithm and serve the output of the default algorithm as the adjustment value currently used.

In other words, in one embodiment, the adjustment value for updating the counting values can be dynamically increased when a packet size of a network packet currently received increases, and the adjustment value for updating the counting values can also be dynamically decreased when a packet size of a network packet currently received decreases. Taking FIG. 3 as an example, if it is assumed that the source IP addresses of two sequentially received network packets A and B are both IP_{A}, and the packet size of network packet A is larger than the packet size of network packet B. In this case, a value increase degree of at least one of the counting values C₁ to C₃ when the counting values C₁ to C₃ are updated corresponding to the network packet A may be greater than a value increase degree of at least one of the counting values C₁ to C₃ when the counting values C₁ to C₃ are updated corresponding to the network packet B.

The heavy network flow detection circuit 25 may obtain a flow-amount evaluation value corresponding to the routing information according to the updated counting values. The flow-amount evaluation value reflects a total number and/or a total data transmission amount of network packets carrying the same (or similar) routing information. Taking FIG. 3 as an example, in one embodiment, the heavy network flow detection circuit 25 may determine the flow-amount evaluation value according to a minimum value of the counting values C₁ to C₃. For example, if the minimum value of the counting values C₁ to C₃ is the counting values C₁, the heavy network flow detection circuit 25 may set the flow-amount evaluation value to be the same with the counting values C₁. In one embodiment, the heavy network flow detection circuit 25 may update the counting values and determine the flow-amount evaluation value by using a count-min sketch algorithm. In addition, in another embodiment of FIG. 3, the flow-amount evaluation value corresponding to the routing information RI may be a maximum value of counting values C₁ to C₃, a median value of counting values C₁ to C₃, an average value of counting values C₁ to C₃, or a weighted average value of counting values C₁ to C₃ or so on, which is not particularly limited in the invention.

The heavy network flow detection circuit 25 may determine whether the flow-amount evaluation value is larger than a threshold value. The threshold value can be determined based on actual network state. For example, the threshold value may be determined according to at least one of a network environment, a flow amount state of part or entire of the SND network, a flow amount payload of at least one SDN switch, and a bandwidth of at least one SDN switch. If the flow-amount evaluation value is larger than the threshold value, the heavy network flow detection circuit 25 may identify that the current network packet belongs to a heavy network flow. Otherwise, the flow-amount evaluation value is not larger than the threshold value, the heavy network flow detection circuit 25 may continuously perform the foregoing operation, such as updating the counting values, for the next received network packets.

In one embodiment of FIG. 1 and FIG. 2, if it is determined that the flow-amount evaluation value is larger than the threshold value, the heavy network flow detection circuit 25 may further record the corresponding routing information (e.g., the foregoing source IP address IP_{A}) into a heavy network flow table. For example, the heavy network flow table may be stored in the heavy network flow detection circuit 25. In a specific time point, the heavy network flow detection circuit 25 may transmit the heavy network flow table to the SDN controller 11 through the network interface 22. For example, the specific time point may be a time point when the heavy network flow table is fully written, a time point when the heavy network flow table is updated, a time point when a default amount of routing information is updated into the heavy network flow table or a regular time point. According to the heavy network flow table, the SDN controller 11 may update the corresponding routing rules to the SDN switches 121 to 124. For example, the SDN controller 11 may instruct the SDN switches 121 to 124 to block all network packets having the same source IP address IP_{A} or performing corresponding defending or flow diverting mechanisms for the network packets having the same source IP address IP_{A}, which is not particularly limited in the invention.

FIG. 5 is a schematic diagram of a heavy network flow detection circuit according to an embodiment of the invention. Referring to FIG. 5, a heavy network flow detection circuit 55 is the same with or similar to the heavy network flow detection circuit 25. In this embodiment, the heavy network flow detection circuit 55 includes a check circuit 551, a memory 552 and a filter 553. The check circuit 551 is configured to perform the forgoing operations, such as generating the index values, updating the counting values and identifying whether a network packet belongs to a heavy network flow. For example, the check circuit 551 may include the hash circuits 301 to 303 of FIG. 3. The memory 552 is configured to store the heavy network flow table. If the check circuit 551 determines that a flow-amount evaluation value corresponding to a specific routing information is larger than the threshold value, the filter 553 may check whether this specific routing information is already recorded in the heavy network flow table. If this specific routing information is not yet recorded in the heavy network flow table, the filter 553 may instruct recording this specific routing information into the heavy network flow table. Otherwise, if this specific routing information is already recorded in the heavy network flow table, the filter 553 may instruct not adding this specific routing information into the heavy network flow table, so as to prevent the same routing information being recorded repeatedly. In one embodiment, the filter 553 may be a bloom filter.

In one embodiment, the heavy network flow detection circuit 55 may not include the filter 553. Therefore, the check circuit 551 may (directly) update the heavy network flow table stored in the memory 552 without the filter 553. In addition, in one embodiment, the hash tables where the counting values recorded may also be stored in the memory 552.

It is noted that, even though three hash circuits (or there hash functions) corresponding to three counting values (or three hash tables) is taken as example in the embodiments of FIG. 3 and FIG. 4, however, in other embodiments not mentioned, the number of hash circuits (or hash functions) and the number of counting values (or hash tables) can be changed, depending on actual implementation. For example, the number of “3” can be changed to “N”, where N is a positive number. In addition, the electronic element layout and coupling relation as mentioned above are merely examples. In other embodiments not mentioned, more electronic elements can be added for providing additional functions. Alternatively, part of the electronic elements in FIG. 2 and FIG. 5 may be replaced with other electronic element with different types, as long as similar functions being provided. In addition, the coupling relation of part electronic elements of FIG. 2 and FIG. 5 may be changed, depending on actual implementation.

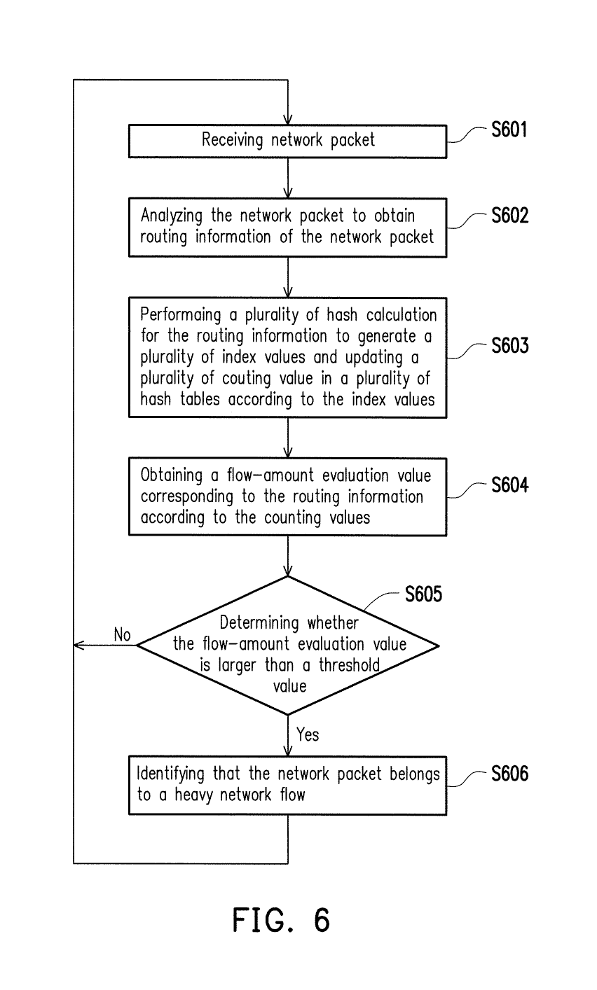

FIG. 6 is a flowchart illustrating a heavy network flow detection method according to an embodiment of the invention. Referring to FIG. 6, in step S601, a network packet is received through a network interface of a SDN switch. In step S602, the network packet is analysed to obtain routing information of the network packet. In step S603, a plurality of hash calculations are performed for the routing information to generate a plurality of index values and a plurality of counting values in a plurality of hash tables are updated according to the index values. In step S604, a flow-amount evaluation value corresponding to the routing information is obtained according to the counting values. In step S605, it is determined whether the flow-amount evaluation value is larger than a threshold value. If it is determined that the flow-amount evaluation value is larger than the threshold value, in step S606, the network packet is identified as belonging to a heavy network flow. If it is determined that the flow-amount evaluation value is not larger than the threshold value, step S601 is entered again, so as to receive and analysis the following network packets.

Nevertheless, each of steps depicted in FIG. 6 has been described in detail as above, and thus related description is not repeated hereinafter. It is noted that, the steps depicted in FIG. 6 may be implemented as a plurality of program codes or circuits, which are not particularly limited in the invention. Moreover, the method disclosed in FIG. 6 may be implemented with reference to above embodiments, or may be implemented separately, which are not particularly limited in the invention.

In summary, after a network packet is received, the SDN switch may analyse the network packet to obtain routing information of the network packet. Then, the SDN switch may perform a plurality of hash calculations on the routing information in parallel and update the corresponding counting values according to the calculation result, so as to obtain a flow-amount evaluation value corresponding to the routing information. If the flow-amount evaluation value is larger than a threshold value, the SDN switch may identify the network packet as belonging to a heavy network flow and report the routing information to the SDN controller. Because the identification operation of the heavy network flow is distributed to the SDN switches, the efficiency of overall flow amount analysis and routing rule management can be improved, and the calculation payload of SDN controller can be reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A heavy network flow detection method for a software-defined networking switch, the heavy network flow detection method comprising receiving a network packet through a network interface;
analyzing the network packet to obtain routing information of the network packet;
performing a plurality of hash calculations for the routing information to generate a plurality of index values and updating a plurality of counting values in a plurality of hash tables according to the index values;
obtaining a flow-amount evaluation value corresponding to the routing information according to the counting values; and
identifying that the network packet belongs to a heavy network flow if the flow-amount evaluation value is larger than a threshold value.

2. The heavy network flow detection method as claimed in claim 1, wherein the routing information comprises at least one of an Internet protocol address and a port number.

3. The heavy network flow detection method as claimed in claim 1, wherein the step of performing the hash calculations for the routing information to generate the index values and updating the counting values in the hash tables according to the index values comprises:
inputting the routing information to a first hash function and a second hash function to obtain a first index value and a second index value respectively, wherein the first hash function relates to a first hash table, and the second hash function relates to a second hash table;
searching a first counting value in the first hash table according to the first index value and adding an adjustment value to the first counting value to update the first counting value; and
searching a second counting value in the second hash table according to the second index value and adding the adjustment value to the second counting value to update the second counting value.

4. The heavy network flow detection method as claimed in claim 3, further comprising:
analyzing the network packet to obtain a packet size of the network packet; and
determining the adjustment value according to the packet size.

5. The heavy network flow detection method as claimed in claim 1, wherein the step of obtaining the flow-amount evaluation value corresponding to the routing information according to the counting values comprises:
determining the flow-amount evaluation value according to a minimum value of the counting values.

6. The heavy network flow detection method as claimed in claim 1, further comprising:
recording the routing information to a heavy network flow table if the flow-amount evaluation value is larger than the threshold value; and
transmitting the heavy network flow table to a software-defined networking controller through the network interface.

7. A software-defined networking switch for a software-defined networking network, the software-defined networking switch comprising:
a network interface, configured to receive a network packet;
a packet analysis interface, coupled to the network interface and configured to analyze the network packet to obtain routing information of the network packet; and
a heavy network flow detection circuit, coupled to the packet analysis interface and configured to:
perform a plurality of hash calculations for the routing information to generate a plurality of index values and update a plurality of counting values in a plurality of hash tables according to the index values;
obtain a flow-amount evaluation value corresponding to the routing information according to the counting values; and
identify that the network packet belongs to a heavy network flow if the flow-amount evaluation value is larger than a threshold value.

8. The software-defined networking switch as claimed in claim 7, wherein the routing information comprises at least one of an Internet protocol address and a port number.

9. The software-defined networking switch as claimed in claim 7, wherein the operation of performing the hash calculations for the routing information to generate the index values and updating the counting values in the hash tables according to the index values by the heavy network flow detection circuit comprises:
inputting the routing information to a first hash function and a second hash function to obtain a first index value and a second index value respectively, wherein the first hash function relates to a first hash table, and the second hash function relates to a second hash table;
searching a first counting value in the first hash table according to the first index value and adding an adjustment value to the first counting value to update the first counting value; and
searching a second counting value in the second hash table according to the second index value and adding the adjustment value to the second counting value to update the second counting value.

10. The software-defined networking switch as claimed in claim 9, wherein the packet analysis interface is further configured to analyze the network packet to obtain a packet size of the network packet, and
the heavy network flow detection circuit is further configured to determine the adjustment value according to the packet size.

11. The software-defined networking switch as claimed in claim 7, wherein the operation of obtaining the flow-amount evaluation value corresponding to the routing information according to the counting values by the heavy network flow detection circuit comprises:
determining the flow-amount evaluation value according to a minimum value of the counting values.

12. The software-defined networking switch as claimed in claim 7, wherein the heavy network flow detection circuit is further configured to record the routing information to a heavy network flow table if the flow-amount evaluation value is larger than the threshold value and transmit the heavy network flow table to a software-defined networking controller through the network interface.
